(19) United States
(12) Patent Application Publication
(10) Pub. No.: US 2020/0229623 A1
(43) Pub. Date: Jul. 23, 2020

(54) WINE-DECANTING CUP STRUCTURE

(71) Applicant: Chang Hsien Liu, Taoyuan City (TW)

(72) Inventor: Chang Hsien Liu, Taoyuan City (TW)

(21) Appl. No.: 16/250,036

(22) Filed: Jan. 17, 2019

(51) Int. Cl. A47G 19/22; B01F 3/04

(52) U.S. Cl. CPC A47G 19/2205; B01F 2215/0072; A47G 2400/045; B01F 3/0446

(57) ABSTRACT

A wine-decanting cup structure includes a bottom wall, an annular wall, and a plurality of protruding ribs. The bottom wall, the annular wall, and the protruding ribs are made of polyethylene terephthalate. A bottom end of the annular wall is connected to the bottom wall to enclose a containing room for receiving wine. An outer diameter of the annular wall gradually increases and then gradually decreases from the bottom end of the annular wall to a top end of the annular wall. The protruding ribs are integrally formed on an inner periphery of the annular wall and spaced apart from each other. Each of the protruding ribs extends in a longitudinal direction and is bent toward a same direction.

### BACKGROUND OF THE INVENTION

### Field of the Invention

The present invention relates to a wine cup, in particular to a wine cup with decanting function.

### Description of the Prior Art

Wine (especially grape wine), would be much mellower if the wine is decanted to arouse the wine aroma and to reduce the sour and bitter taste. The principle for wine decanting is to allow the wine liquid to contact air and make the wine liquid be oxidized properly. Structures of decanters on the market are thus designed based on this principle.

However, the decanters on the market have different flow path designs and have complex structures, thus being expensive. Furthermore, these conventional decanters are independent from the wine bottle or the wine glass. The user has to assemble the decanter on the wine bottle or the wine glass before decanting the wine, resulting in inconvenience for the decanting process.

### SUMMARY OF THE INVENTION

One object of the present invention is to provide a wine-decanting cup structure, and the protruding ribs on the inner side of the cup structure obstruct the flowing of the wine liquid. Thus, the wine liquid can be splashed within the cup structure to increase the contact area between the wine liquid and air, thereby providing decanting function.

In view of these, a wine-decanting cup structure is provided. In one embodiment, the wine-decanting cup structure comprises a bottom wall, an annular wall, and a plurality of protruding ribs. A bottom end of the annular wall is connected to the bottom wall to enclose a containing room for receiving wine. An outer diameter of the annular wall gradually increases and then gradually decreases from the bottom end of the annular wall to a top end of the annular wall. The protruding ribs are integrally formed on an inner periphery of the annular wall and spaced apart from each other. Each of the protruding ribs extends in a longitudinal direction and is bent toward a same direction. The bottom wall, the annular wall, and the protruding ribs are made of polyethylene terephthalate.

In one embodiment, the top end of the annular wall forms an opening, and a first engaging portion is extending inwardly from an inner side of the opening. An annular groove is formed between the bottom end of the annular wall and a portion on an outer periphery of the annular wall having the largest outer diameter. An inner periphery of the annular wall has a protruding portion and a position of the protruding portion corresponds to a position of the annular groove. A shape of the first engaging portion corresponds to a shape of the annular groove, so that the wine-decanting cup structure is adapted to be connected to an adjacent wine-decanting cup structure by engaging the first engaging portion of the wine-decanting cup structure with the annular groove of the adjacent wine-decanting cup structure.

In one embodiment, the wine-decanting cup structure further comprises a standing member. A top end of the standing member comprises an upper combining portion, and a bottom end of the standing member comprises a lower combining portion. The upper combining portion is recessed and has an upper flange, a second engaging portion is extending inwardly from an inner side of the upper flange, and the second engaging portion is adapted to be engaged with the annular groove of the annular wall. The lower combining portion is recessed and has a lower flange, a third engaging portion is extending outwardly from an outer side of the lower flange, and the third engaging portion is adapted to be engaged with the first engaging portion of the annular wall.

### BRIEF DESCRIPTION OF THE DRAWINGS

FIG. 1 illustrates a sectional view of a wine-decanting cup structure according to a first embodiment of the present invention;

FIG. 2 illustrates a schematic operational view showing that the wine-decanting cup structure of the first embodiment is used for decanting wine;

FIG. 3 illustrates a sectional view of a wine-decanting cup structure according to a second embodiment of the present invention;

FIGS. 4 and 5 illustrate schematic operational views showing that the wine-decanting cup structure of the second embodiment is used for decanting wine;

FIG. 6 illustrates a schematic operational view showing that the wine-decanting cup structures of the second embodiment are stacked;

FIG. 7 illustrates an exploded sectional view of a wine-decanting cup structure according to a third embodiment of the present invention; and

FIGS. 8 and 9 illustrate schematic operational views showing that the wine-decanting cup structures of the third embodiment are stacked.

### DETAIL DESCRIPTION OF THE PREFERRED EMBODIMENTS

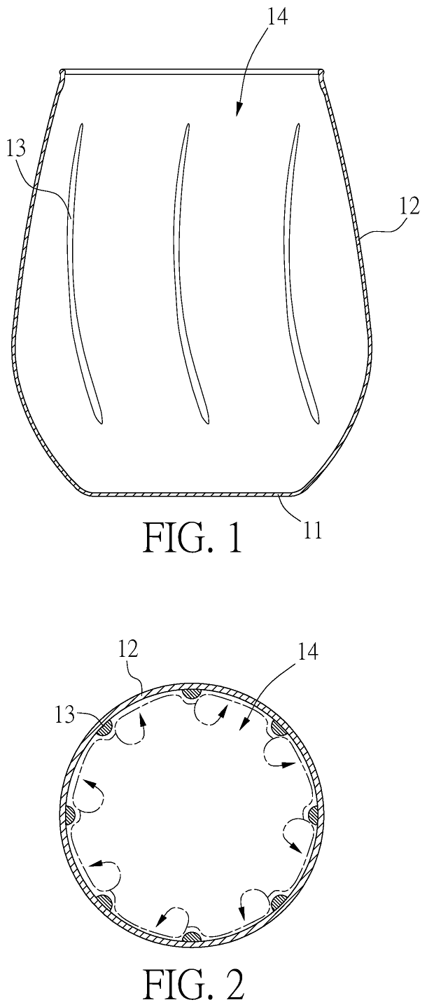

Please refer to FIG. 1, illustrating a wine-decanting cup structure according to a first embodiment of the present invention. In the embodiment, the wine-decanting cup structure comprise a bottom wall 11, an annular wall 12, and a plurality of protruding ribs 13, and the bottom wall 11, the annular wall 12, and the protruding ribs 13 are made of polyethylene terephthalate (PET). A bottom end of the annular wall 12 is connected to the bottom wall 11 to enclose a containing room 14 for receiving wine. An outer diameter of the annular wall 12 gradually increases and then gradually decreases from the bottom end of the annular wall 12 to a top end of the annular wall 12. Therefore, a portion of the annular wall 12 having the largest outer diameter is between the top end of the annular wall 12 and the bottom end of the annular wall 12.

Moreover, the ribs 13 are integrally formed on an inner periphery of the annular wall 12. The protruding ribs 13 are spaced apart from each other, extending in a longitudinal direction, and bent toward a same direction. As shown in FIG. 2, each of the protruding ribs 13 is protruding from an inner periphery of the annular wall 12, so that the inner periphery of the annular wall 12 is not a flat surface.

Accordingly, when a user pours wine into the containing room 14 and shakes the wine-decanting cup structure, the wine liquid flows along the inner periphery of the annular wall 12 to perform a whirlpool motion. Then, the protruding ribs 13 obstruct the flowing of the wine liquid, and the wine liquid cannot flow smoothly after the wine liquid impacts the protruding ribs 13, thus producing broken wine sprays. Therefore, the contact area between the wine liquid and air increases, thereby the wine can be decanted. The advantage of the embodiment of the present invention is that, the wine can be decanted by the wine-decanting cup structure having a simple structural design, rather than by a complex decanting device, and thus the wine-decanting cup structure can be used conveniently.

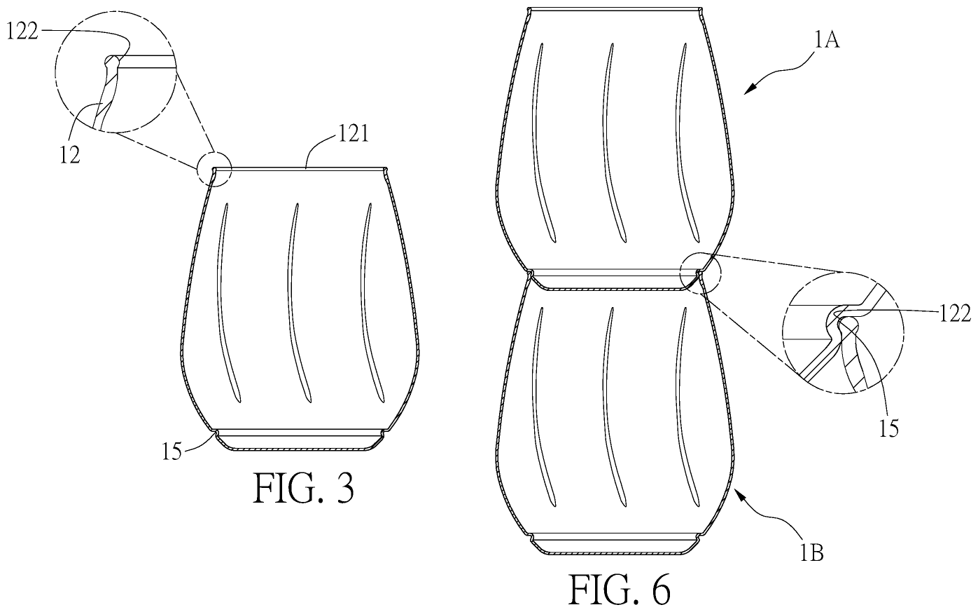

FIG. 3 illustrates a wine-decanting cup structure according to a second embodiment of the present invention. The second embodiment is based on the first embodiment and further comprises an opening 121 formed on the top end of the annular wall 12. A first engaging portion 122 is extending inwardly from an inner side of the opening 121 and the first engaging portion 122 is of a ring shape. On the other hand, an annular groove 15 is formed between the bottom end of the annular wall 12 and a portion on an outer periphery of the annular wall 12 having the largest outer diameter. An inner periphery of the annular wall 12 has a protruding portion and a position of the protruding portion corresponds to a position of the annular groove 15.

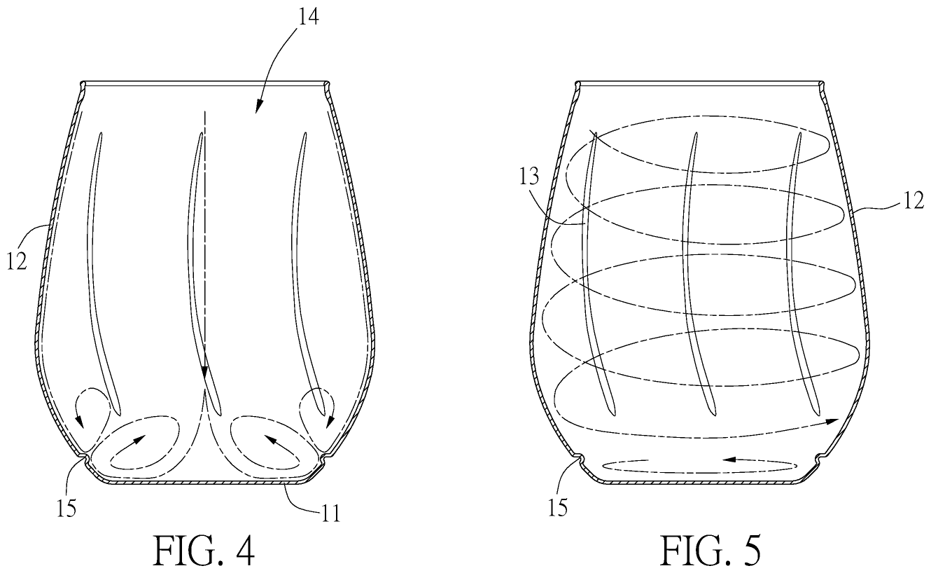

Accordingly, when a user pours wine into the containing room 14, as shown in FIG. 4, a portion of the wine liquid falling from a middle portion of the containing room 14 is splashed after the wine liquid impacts on the bottom wall 12 and then the portion of the wine liquid impacts the protruding portion of the annular groove 15 formed on the inner periphery of the annular wall 12. Therefore, the flowing of the portion of the wine liquid is obstructed to produce wine sprays. On the other hand, a portion of the wine liquid flowing along the inner periphery of the annular wall 12 also impacts the protruding portion of the annular groove 15 formed on the inner periphery of the annular wall 12. Therefore, the flowing of the portion of the wine liquid is obstructed to produce wine sprays. Hence, the contact area between the wine liquid and air increases, thereby the wine can be decanted.

Furthermore, when the user shakes the wine-decanting cup structure, as shown in FIG. 5, the wine liquid flows along the inner periphery of the annular wall 12 to perform a whirlpool motion. Therefore, the wine liquid can be decanted not only by impacting the wine liquid on the protruding ribs 13, but also by utilizing the protruding portion of the annular groove 15 formed on the inner periphery of the annular wall 12 to obstruct the whirlpool motion of the wine liquid and form two separate swirls. The two separate swirls then impact and interfere with each other so as to produce wine sprays. Hence, the contact area between the wine liquid and air increases, thereby the wine can be decanted.

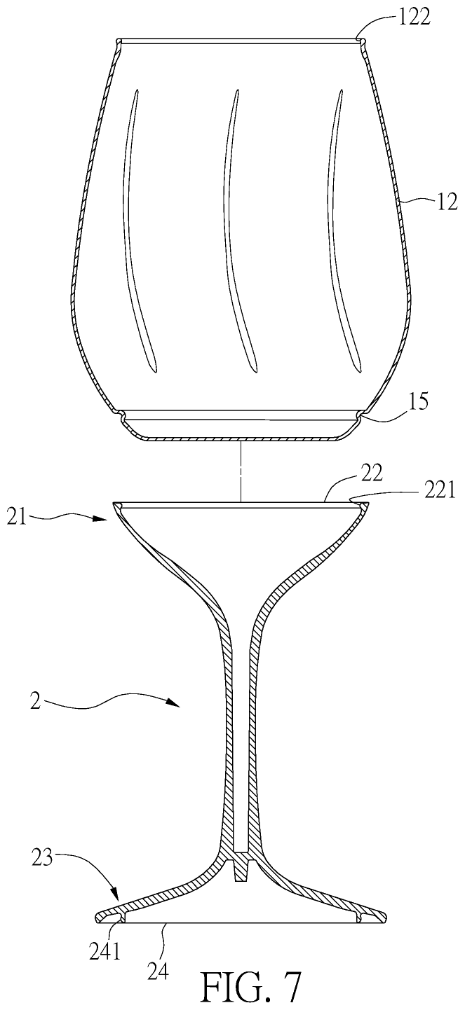

Furthermore, a protruding shape of the first engaging portion 122 corresponds to a recessing shape of the annular groove 15, so that, as shown in FIG. 6, adjacent wine-decanting cup structures 1A, 1B can be connected with each other by engaging the first engaging portion 122 of the wine-decanting cup structure 1A with the annular groove 15 of the wine-decanting cup structure 1B.

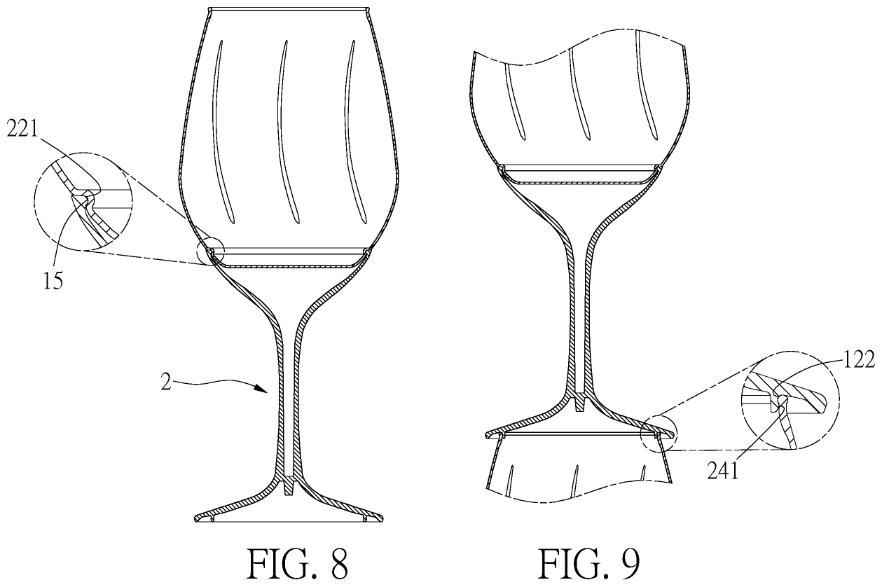

FIG. 7 illustrates a wine-decanting cup structure according to a third embodiment of the present invention. The third embodiment is based on the second embodiment and further comprises a standing member 2. A top end of the standing member 2 comprises an upper combining portion 21. The upper combining portion 21 is recessed and has an upper flange 22, and a second engaging portion 221 is extending inwardly from an inner side of the upper flange 22. The second engaging portion 221 is adapted to be engaged with the annular groove 15 of the annular wall 12. Therefore, as shown in FIG. 8, the annular groove 15 can be engaged with and fastened with the second engaging portion 221, so that the wine-decanting cup structure forms a goblet configuration.

Moreover, a bottom end of the standing member 2 comprises a lower combining portion 23. The lower combining portion 23 is recessed and has a lower flange 24, and a third engaging portion 241 is extending outwardly from an outer side of the lower flange 24. The third engaging portion 241 is adapted to be engaged with the first engaging portion 122 of the annular wall 12. Therefore, as shown in FIG. 9, two wine-decanting cup structures in goblet configuration can be connected with each other by engaging the first engaging portion 122 of one goblet with the third engaging portion 241 of the other goblet.

What is claimed is:

1. A wine-decanting cup structure, comprising:
a bottom wall;
an annular wall, wherein a bottom end of the annular wall is connected to the bottom wall to enclose a containing room for receiving wine, an outer diameter of the annular wall gradually increases and then gradually decreases from the bottom end of the annular wall to a top end of the annular wall; and
a plurality of protruding ribs integrally formed on an inner periphery of the annular wall and spaced apart from each other, wherein each of the protruding ribs extends in a longitudinal direction and is bent toward a same direction;
wherein the bottom wall, the annular wall, and the protruding ribs are made of polyethylene terephthalate.

2. The wine-decanting cup structure according to claim 1, wherein the top end of the annular wall forms an opening, a first engaging portion is extending inwardly from an inner side of the opening; an annular groove is formed between the bottom end of the annular wall and a portion on an outer periphery of the annular wall having the largest outer diameter; an inner periphery of the annular wall has a protruding portion and a position of the protruding portion corresponds to a position of the annular groove; wherein a shape of the first engaging portion corresponds to a shape of the annular groove, so that the wine-decanting cup structure is adapted to be connected to an adjacent wine-decanting cup structure by engaging the first engaging portion of the wine-decanting cup structure with the annular groove of the adjacent wine-decanting cup structure.

3. The wine-decanting cup structure according to claim 2, further comprising a standing member, wherein a top end of the standing member comprises an upper combining portion, and a bottom end of the standing member comprises a lower combining portion, the upper combining portion is recessed and has an upper flange, a second engaging portion is extending inwardly from an inner side of the upper flange, and the second engaging portion is adapted to be engaged with the annular groove of the annular wall; the lower combining portion is recessed and has a lower flange, a third engaging portion is extending outwardly from an outer side of the lower flange, and the third engaging portion is adapted to be engaged with the first engaging portion of the annular wall.
